(19) United States
(12) Patent Application Publication
(10) Pub. No.: US 2026/0087839 A1
(43) Pub. Date: Mar. 26, 2026

(54) INFORMATION PROCESSING SYSTEM, INFORMATION PROCESSING METHOD, AND RECORDING MEDIUM IN WHICH INFORMATION PROCESSING PROGRAM IS RECORDED

(71) Applicant: Sharp Kabushiki Kaisha, Sakai City (JP)

(72) Inventor: Teruhiko MATSUOKA, Sakai City (JP)

(21) Appl. No.: 19/327,173

(22) Filed: Sep. 12, 2025

(30) Foreign Application Priority Data
Sep. 24, 2024 (JP) 2024-165159

(51) Int. Cl. G06V 30/12; G06V 30/148; G06V 30/16; G06V 30/18; G06V 30/412

(52) U.S. Cl. CPC G06V 30/12; G06V 30/155; G06V 30/16; G06V 30/18105; G06V 30/412

(57) ABSTRACT

An image processing apparatus includes an extraction processing unit that extracts a target object that is at least one of a text object and a drawing object from document data, a correction processing unit (a substitution processing unit, a deletion processing unit, and a change processing unit) that executes predetermined correction processing on the target object extracted by the correction processing unit when the target object matches an object to be processed that is registered in advance, and a rendering processing unit that generates image data for character recognition by executing render processing on the document data of which the target object has been corrected by the correction processing unit.

### INCORPORATION BY REFERENCE

This application is based upon and claims the benefit of priority from the corresponding Japanese Patent Application No. 2024-165159 filed on Sep. 24, 2024, the entire contents of which are incorporated herein by reference.

### BACKGROUND

The disclosure relates to a technique for executing image processing such as character recognition on an input image.

Techniques for recognizing characters of document data of forms and the like (OCR processing) are known in the related art. For example, a technique is known in which a character object is determined from image data obtained by rendering page description language (PDL) data, and character recognition processing is performed on the determined character object to extract character code information.

However, in the related art, for example, in a case where document data (document file) such as PDF data is rendered (conversion processing for converting into an image) to obtain a picture, there is a problem that character recognition accuracy is lowered, such as garbled characters when a character code not corresponding to a font usable in the conversion processing is included, difficulty in recognizing characters due to a seal imprint image overlapping the characters in an OCR processing after the conversion processing, or difficulty in recognizing characters due to the influence of an underlay background.

### SUMMARY

An object of the disclosure is to provide an image processing system, an image processing method, and a recording medium in which an image processing program is recorded that are capable of improving character recognition accuracy by appropriately rendering document data.

An information processing system according to an aspect of the disclosure includes an extraction processing unit, a correction processing unit, and a generation processing unit. The extraction processing unit extracts a target object that is at least one of a text object and a drawing object from document data. The correction processing unit executes predetermined correction processing on the target object extracted by the correction processing unit when the target object matches an object to be processed that is registered in advance. The generation processing unit generates image data for character recognition by executing render processing on the document data of which the target object has been corrected by the correction processing unit.

In an information processing method according to another aspect of the disclosure, one or more processors perform extracting a target object that is at least one of a text object and a drawing object from document data, executing predetermined correction processing on the target object when the target object matches an object to be processed that is registered in advance, and generating image data for character recognition by executing render processing on the document data of which the target object has been corrected in the predetermined correction processing.

A recording medium according to another aspect of the disclosure is a recording medium having a program recorded therein, the program causing one or more processors to execute extracting a target object that is at least one of a text object and a drawing object from document data, executing predetermined correction processing on the target object when the target object matches an object to be processed that is registered in advance, and generating image data for character recognition by executing render processing on the document data of which the target object has been corrected in the predetermined correction processing.

According to the disclosure, it is possible to provide an image processing system, an image processing method, and a recording medium in which an image processing program is recorded that are capable of improving character recognition accuracy by appropriately rendering document data.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a function block diagram illustrating a configuration of an image processing system according to an embodiment of the disclosure.

FIG. 2 is a diagram illustrating an example of a document (PDF file) according to the embodiment of the disclosure.

FIG. 3 is a flowchart illustrating an example of a procedure of character extraction processing executed in an image processing apparatus according to the embodiment of the disclosure.

FIG. 4 is a diagram illustrating a concrete example of a substitute character list utilized in the image processing apparatus according to the embodiment of the disclosure.

FIG. 5 is a flowchart illustrating an example of a procedure of specific character substitution processing executed in the image processing apparatus according to the embodiment of the disclosure.

FIG. 6 is a flowchart illustrating an example of a procedure of specific image deletion processing executed in the image processing apparatus according to the embodiment of the disclosure.

FIG. 7A is a diagram illustrating a concrete example of a seal imprint image included in an image object according to the embodiment of the disclosure.

FIG. 7B is a diagram illustrating a concrete example of the seal imprint image included in the image object according to the embodiment of the disclosure.

FIG. 7C is a diagram illustrating a concrete example of the seal imprint image included in the image object according to the embodiment of the disclosure.

FIG. 7D is a diagram illustrating a concrete example of the seal imprint image included in the image object according to the embodiment of the disclosure.

FIG. 8 is a flowchart illustrating an example of a procedure of underlay background change processing executed in the image processing apparatus according to the embodiment of the disclosure.

FIG. 9A is a diagram illustrating a concrete example of a table to be subjected to the underlay background change processing according to the embodiment of the disclosure.

FIG. 9B is a diagram illustrating an example of the table with an underlay background being changed according to the embodiment of the disclosure.

FIG. 9C is a diagram illustrating an example of the table with the underlay background being changed according to the embodiment of the disclosure.

FIG. 10A is a diagram illustrating a concrete example of characters and a background to be subjected to the underlay background change processing according to the embodiment of the disclosure.

FIG. 10B is a diagram illustrating a concrete example of the characters and the background to be subjected to the underlay background change processing with the characters and the background being changed according to the embodiment of the disclosure.

FIG. 10C is a diagram illustrating a concrete example of the characters and the background to be subjected to the underlay background change processing with the characters and the background being changed according to the embodiment of the disclosure.

### DETAILED DESCRIPTION

Embodiments of the disclosure are described below with reference to the drawings. Note that the following embodiments are concrete examples of the disclosure, and do not limit the technical scope of the disclosure.

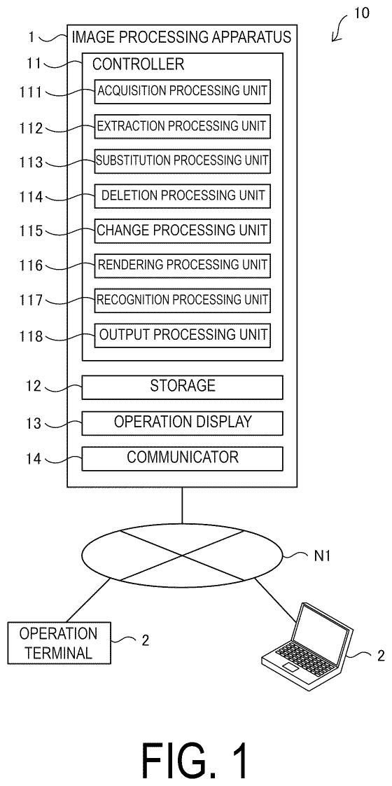

FIG. 1 is a block diagram illustrating a configuration of an image processing system 10 according to an embodiment of the disclosure. The image processing system 10 includes an image processing apparatus 1 and an operation terminal 2. The image processing apparatus 1 and the operation terminal 2 are connected to each other via a network N1 (for example, the Internet, a LAN, or the like). The image processing system 10 may include a plurality of operation terminals 2.

In the image processing system 10, the image processing apparatus 1 acquires document data (or document image data) such as a form transmitted from the operation terminal 2, and extracts a desired character string (a character string to be managed) from the document data. For example, the operation terminal 2 transmits, to the image processing apparatus 1, the document image data (such as a PDF file) generated by scanning a paper-based form such as an invoice, an estimate, a delivery slip, an order sheet, a receipt, a receipt slip, or other documents. The operation terminal 2 creates a document file of the form based on a user operation by, for example, a document creation application, and transmits the document file as document data (PDF file, etc.) to the image processing apparatus 1. When the image processing apparatus 1 receives the document data transmitted from the operation terminal 2, the image processing apparatus 1 executes various processes described later on the document data, and extracts a character string to be managed included in the form. For example, the image processing apparatus 1 extracts a classification (type) of each form, a date of each form, an amount of money (total amount of money, etc.), company information (issuer, destination, registration number, etc.), and the like. The image processing apparatus 1 registers the extracted character string in a predetermined database. For example, every time the image processing apparatus 1 acquires document data of an invoice, the image processing apparatus 1 extracts character strings related to content of the invoice (for example, issue date, amount billed, issuer, and the like) from the document data, and registers the character strings in a database that manages the invoices. Further, every time the image processing apparatus 1 acquires document data of a receipt slip, the image processing apparatus 1 extracts character strings related to content of the receipt slip (for example, issue date, total amount, issuer, and the like) from the document data, and registers the character strings in a database that manages the receipt slips. Thus, each form can be stored and managed as electronic data. The image processing apparatus 1 outputs the extracted character strings to the operation terminal 2 or the like, and presents character recognition results to the user. The image processing system 10 is not limited to the form management, and can be applied to various fields such as document search.

The image processing system 10 is an example of an information processing system according to the disclosure. Note that the information processing system according to the disclosure may include the image processing apparatus 1 alone.

### Image Processing Apparatus 1

As illustrated in FIG. 1, the image processing apparatus 1 includes a controller 11, a storage 12, an operation display 13, a communicator 14, and the like. The image processing apparatus 1 may be one or more cloud servers or one or more physical servers.

The communicator 14 is a communication interface for connecting the image processing apparatus 1 to the network N1 by wire or wirelessly and perform data communication with the operation terminal 2 via the network N1 according to a predetermined communication protocol. The network N1 includes, for example, the Internet, a LAN, or the like.

The operation display 13 is a user interface including a display, such as a liquid crystal display or an organic EL display, that displays various types of information, and an operation inputter, such as a mouse, a keyboard, or a touch panel, that receives an operation.

The storage 12 is a non-volatile storage, such as a hard disk drive (HDD), a solid state drive (SSD), or flash memory, that stores various types of information. The storage 12 stores control programs that cause the controller 11 to execute character extraction processing described later. For example, the control program is non-transiently recorded in a computer-readable recording medium such as a CD or a DVD, read by a reading apparatus (not illustrated) such as a CD drive or a DVD drive included in the image processing apparatus 1, and stored in the storage 12. Note that the control programs may be distributed from a cloud server and stored in the storage 12.

The storage 12 also stores the document data (PDF file or the like) of the forms or the like acquired from the operation terminal 2.

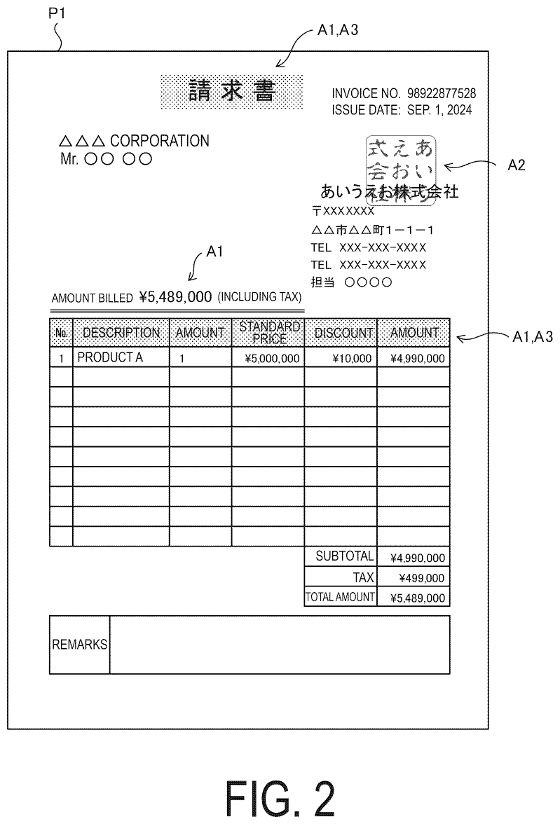

FIG. 2 illustrates an invoice as an example of the form (document data P1). As illustrated in FIG. 2, the invoice includes character strings such as a document classification (“invoice”), an issue date, a contact address of an issuer (an address, a telephone number, a FAX number, a person in charge), an amount billed, a product name, a quantity, a standard price, a discount amount, a subtotal, a consumption tax, and a total amount. The user uses the operation terminal 2 to scan the invoice and upload document data P1 (PDF file) to the image processing apparatus 1. The controller 11 acquires and stores in the storage 12 the document data P1 of the invoice. Note that in the document data P1 in FIG. 2, a symbol A1 represents a text object, a symbol A2 represents an image object, and a symbol A3 represents a path object.

As another embodiment, the controller 11 may acquire a document file of the forms created in the operation terminal 2 and store the document file in the storage 12.

The controller 11 includes control devices such as a CPU, a ROM, and a RAM. The CPU is a processor that executes various types of arithmetic processing. The ROM stores in advance control programs such as a BIOS and an OS for causing the CPU to execute various types of processing. The RAM stores various types of information and is used as a temporary storage memory (work area) for the various types of processing executed by the CPU. The controller 11 controls the image processing apparatus 1 by causing the CPU to execute various types of the control programs stored in advance in the ROM or the storage 12.

Specifically, the controller 11 includes various processing units such as an acquisition processing unit 111, an extraction processing unit 112, a substitution processing unit 113, a deletion processing unit 114, a change processing unit 115, a rendering processing unit 116, a recognition processing unit 117, and an output processing unit 118, as illustrated in FIG. 1. Note that the controller 11 functions as the various processors by executing various types of processing in accordance with the control programs. Further, some or all of the processing units included in the controller 11 may be constituted by an electronic circuit. Note that the control program may be a program for causing a plurality of processors to function as the various types of processors.

### Character Extraction Processing (Entire Flow)

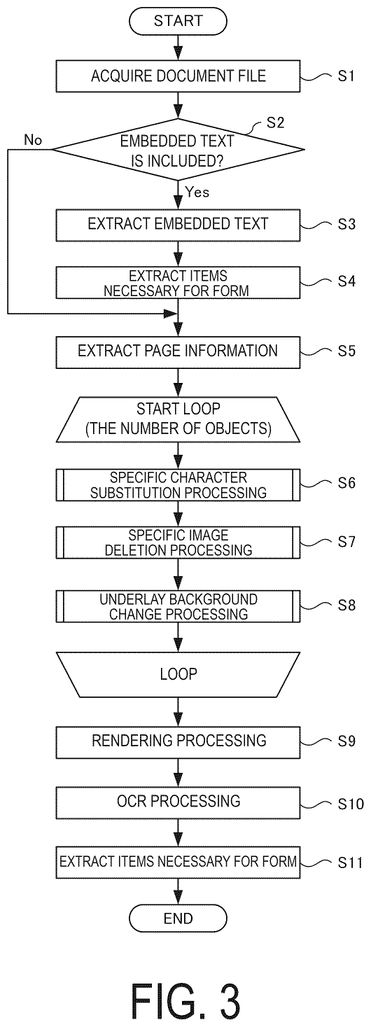

Here, the controller 11, when acquiring the document data P1 (document file), executes rendering processing on the document data P1 and executes character recognition processing (OCR processing) on image data made into a picture by the rendering processing to extract characters of necessary items in a form. Further, the controller 11 executes, as preprocessing of the rendering processing, specific character substitution processing of substituting a character that is included in the text object in the document data P1 and is possibly garbled with a character that is recognizable in the OCR processing, specific image deletion processing of deleting an image object of a seal imprint in the document data P1, and underlay background change processing of changing colors of the text object and a background in the document data P1. FIG. 3 illustrates an example of a procedure of the character extraction processing including the above processing.

Note that the disclosure can be understood as a character recognition method that performs one or more steps included in the character recognition processing. In addition, one or more steps included in the character extraction processing described herein may be omitted as appropriate. In addition, each of the steps of the character extraction processing may be performed in a different order to the extent that similar effects are obtained. Furthermore, although the example is described here in which the controller 11 of the image processing apparatus 1 performs each of the steps of the character extraction processing, in another embodiment, one or more processors may perform each of the steps of the character extraction processing. In addition, the controller 11, when acquiring the document data P1 from each of the plurality of operation terminals 2, can execute the character extraction processing in parallel for each piece of the document data P1.

In step S1, the controller 11 (acquisition processing unit 111) determines whether the document data P1 (document file, PDF file) of the form to be processed has been acquired from the operation terminal 2. The controller 11, when acquiring the document data P1 from the operation terminal 2 (Yes in S1), proceeds to a process of step S2. The controller 11 waits until acquiring the document data P1 from the operation terminal 2 (No in S1).

In step S2, the controller 11 (extraction processing unit 112) determines whether the document data P1 includes embedded text information that can be extracted. The controller 11, when determining that the document data P1 includes the text information (Yes in S2), proceeds to a process of step S3. On the other hand, the controller 11, when determining that the document data P1 does not include the text information (No in S2), proceeds to a process of step S5.

In step S3, the controller 11 (extraction processing unit 112) extracts the embedded text information from the document data P1.

In step S4, the controller 11 (extraction processing unit 112) extracts contents (character strings) of the items necessary for the form from the extracted embedded text information. For example, the extraction processing unit 112 extracts a classification, an amount of money, a date, a customer, a registration number, and the like. The extraction processing unit 112 registers each extracted character string in the database that manages the invoices.

In step S5, the controller 11 (extraction processing unit 112) extracts page information of the document data P1. For example, the extraction processing unit 112 extracts vertical and horizontal sizes of a page, the number of objects, a resolution, color information, and the like.

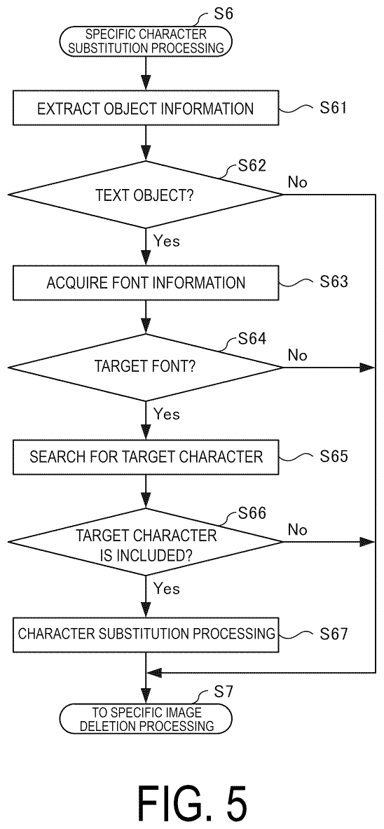

Subsequently, the controller 11 executes the processes of steps S6 to S8 for each object, other than the embedded text information, included in the document data P1. In step S6, the controller 11 (substitution processing unit 113) executes the specific character substitution processing. To be specific, the controller 11 substitutes a character to be garbled in the text object included in the document data P1 with a character (alternative character) that is recognizable in the OCR processing. A concrete example of the specific character substitution processing (see FIG. 5) is described later. The substitution processing unit 113 is an example of a correction processing unit according to the disclosure.

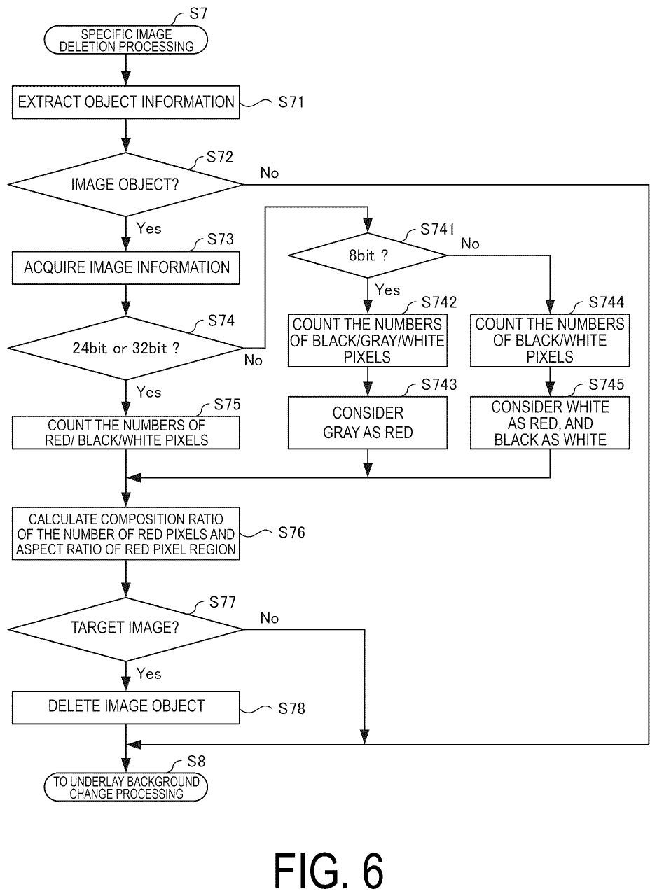

In step S7, the controller 11 (deletion processing unit 114) executes the learning processing. To be specific, the controller 11 deletes the image object of the seal imprint included in the document data P1. A concrete example of the specific image deletion processing (see FIG. 6) is described later. The deletion processing unit 114 is an example of the correction processing unit according to the disclosure.

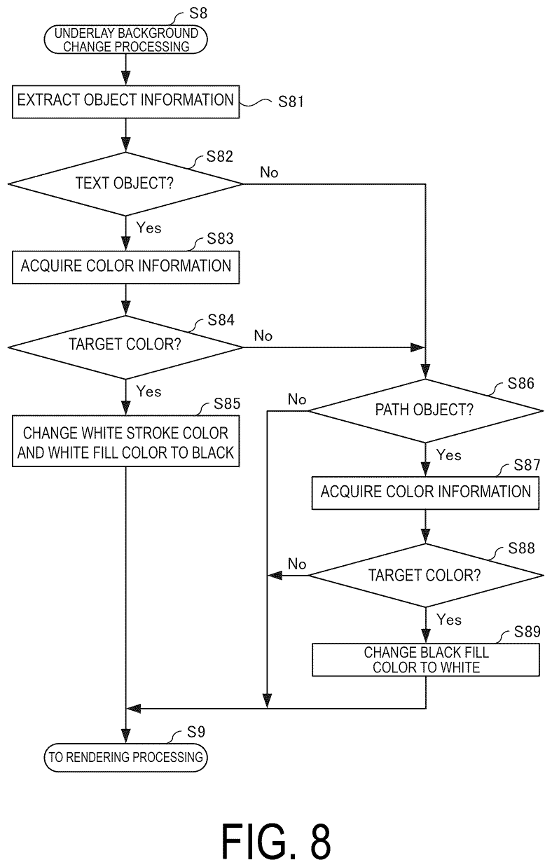

In step S8, the controller 11 (change processing unit 115) executes the underlay background change processing. To be more specific, the controller 11 changes the colors of the text object and the background in the document data P1. A concrete example of the underlay background change processing (see FIG. 8) is described later. The change processing unit 115 is an example of the correction processing unit according to the disclosure.

The controller 11 repeatedly executes the processes of steps S6 to S8 described above by the number of objects included in the document data P1. Note that the specific character substitution processing, the specific image deletion processing, and the underlay background change processing may be executed in any order or in parallel.

The controller 11, after executing the processes of steps S6 to S8 described above for all the objects, proceeds to a process of step S9. In step S9, the controller 11 (rendering processing unit 116) executes the rendering processing. To be more specific, the rendering processing unit 116 executes the rendering processing (picture making processing) on the document data P1 to generate image data for character recognition (OCR). The rendering processing unit 116 is an example of a generation processing unit according to the disclosure.

In step S10, the controller 11 (recognition processing unit 117) executes the OCR processing on the image data to recognize a character. For example, the controller 11 uses AI learning type OCR to recognize a character. In step S10, the controller 11 executes pre-processing such as character inversion and italic type correction processing before the OCR processing.

In step S11, the controller 11 (output processing unit 118) outputs the character recognition results (OCR results). Specifically, the output processing unit 118 extracts the contents (character strings) of the items necessary for the form from the character recognition results. The extraction processing unit 112 registers each extracted character string in the database that manages the invoices.

Hereinafter, the concrete example of each of the specific character substitution processing (step S6), the specific image deletion processing (step S7), and the underlay background change processing (step S8) included in the character extraction processing is described.

### Specific Character Substitution Processing

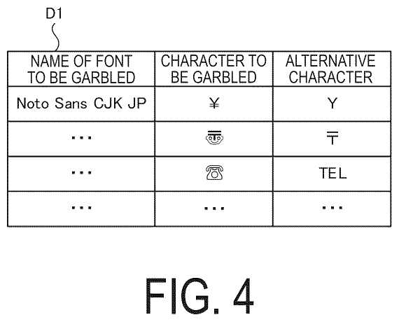

In the specific character substitution processing, when the extraction processing unit 112 extracts a text object from the document data P1, if a character string in the text object includes a character to be corrected (to be substituted), the substitution processing unit 113 substitutes the character with a predetermined character that is registered in advance in association with the character to be corrected. To be more specific, the substitution processing unit 113 refers to a substitute character list D1 (see FIG. 4) storing a name of a font to be garbled, a character to be garbled, and a substitute character (alternative character) in association with each other, identifies the alternative character associated with the character to be corrected that is to be garbled, and substitutes the character with the alternative character.

FIG. 4 illustrates an example of the substitute character list D1. In the substitute character list D1, the names of the fonts that are possibly garbled, the characters that are possibly garbled, and the alternative characters to be substituted with the characters are registered in advance in association with each other. Note that the character that is possibly garbled is not limited to a text character, and may be a pictogram, a symbol, or the like.

FIG. 5 illustrates an example of the procedure of the specific character substitution processing.

### Step S61

In step S61, the controller 11 (extraction processing unit 112) extracts object information from the document data P1. To be specific, the controller 11 extracts a text object, a drawing object (an image object, a path object), and the like from the document data P1 (see FIG. 2).

### Step S62

In step S62, the controller 11 (substitution processing unit 113) determines whether the extracted object as a target object is a text object. If the target object is a text object (Yes in S62), the substitution processing unit 113 proceeds to a process of step S63. On the other hand, if the target object is not a text object (No in S62), the substitution processing unit 113 proceeds to a process of step S7 (specific image deletion processing).

### Step S63

In step S63, the controller 11 (substitution processing unit 113) acquires font information used in the rendering processing from the text object.

### Step S64

In step S64, the controller 11 (substitution processing unit 113) determines whether the acquired font is a font to be substituted. Specifically, the substitution processing unit 113 determines whether the acquired font is a font that is possibly garbled. The substitution processing unit 113 determines that the acquired font is a font to be substituted when the acquired font matches the “name of font to be garbled” in the substitute character list D1 (see FIG. 4). The substitution processing unit 113, when determining that the acquired font is a font to be substituted (Yes in S64), proceeds to a process of step S65. On the other hand, the substitution processing unit 113, when determining that the acquired font is not a font to be substituted (No in S64), proceeds to a process of step S7 (specific image deletion processing).

### Step S65

In step S65, the controller 11 (substitution processing unit 113) searches the character string in the text object for the target character to be garbled. To be more specific, the substitution processing unit 113 searches the character string in the extracted text object for a character that matches the “character to be garbled” registered in the substitute character list D1.

### Step S66

In step S66, the controller 11 (substitution processing unit 113) proceeds to a process of step S67 when the target character to be garbled is included in the character string in the text object (Yes in S66), or proceeds to a process of step S7 (specific image deletion processing) when no target character to be garbled is included (No in S66).

### Step S67

In step S67, the controller 11 (substitution processing unit 113) substitutes the target character to be garbled with a character registered in advance. To be more specific, the substitution processing unit 113 substitutes the target character with the “alternative character” registered in the substitute character list D1. The substitution processing unit 113, after completing substituting the target character to be garbled with another character (alternative character), proceeds to a process of step S7 (specific image deletion processing).

As described above, the substitution processing unit 113 executes the specific character substitution processing. For example, there may be a case where a character “¥” of a specific font is garbled into “\ (back slash)” in the rendering processing and is erroneously recognized as “1” in the OCR processing. In this case, the substitution processing unit 113 substitutes the character “¥” with the character “Y” that is less likely to be garbled in the rendering processing. Accordingly, the rendering processing unit 116 can make the character “Y” into a picture with no garble. Then, the recognition processing unit 117 can recognize the character “Y” without erroneously recognizing the character “Y” as “1” in the OCR processing (step S10 in FIG. 3). The output processing unit 118 can extract “Y+numerals” as an amount of money in a process of extracting the items necessary for the form (step S11 in FIG. 3).

As described above, in the specific character substitution processing, the controller 11 registers, in advance, information on the name of the font to be garbled, information on the character to be garbled, and information on the substitute character in a database (substitute character list D1 (see FIG. 5)) or the like. When a text object is present, the controller 11 determines whether a font of the text object upon rendering the text object is a font to be garbled that is registered in advance. When a font to be garbled is used, the controller 11 checks whether a character to be garbled is present in the text object using the font, and substitutes the character, if present, with a predetermined character registered in advance. Accordingly, when extracting, for example, numerals expressing an amount of money from the OCR result, the controller 11 can extract the correct amount of money by configuring a condition such that “Y”, if present at the beginning of a character string of the numerals, is regarded as “¥” and characters other than the numerals are ignored.

### Specific Image Deletion Processing

In the specific image deletion process, when the extraction processing unit 112 extracts an image object that is a drawing object from the document data P1, the deletion processing unit 114 determines whether the image object is a seal imprint image to be deleted based on the number of or a region of pixels of a predetermined color among a plurality of pixels included in the image object, and deletes the image object when determining that the image object is the seal imprint image. The deletion processing unit 114 determines whether the image object is the seal imprint image based on a ratio of the number of red pixels to the number of pixels of colors other than red among a plurality of pixels included in the image object or an aspect ratio of rectangular sizes of a region of the red pixels.

For example, when a color format of the image object is 24-bit or 32-bit, the deletion processing unit 114 counts the number of pixels of each of red, black, and white, and determines whether the image object is the seal imprint image based on the ratio of the counted numbers of pixels or the aspect ratio of the red pixel region. In addition, when the color format of the image object is 8-bit, the deletion processing unit 114 counts the number of pixels of each of black, gray, and white, further recounts the number for gray as that for red in a case where a pixel of gray is present, or recounts the number for white as that for red and the number for black as that for white in a case where no pixel of gray is present, and determines whether the image object is the seal imprint image based on the ratio of the counted numbers of pixels or the aspect ratio of the red pixel region. In addition, when the color format of the image object is 1-bit, the deletion processing unit 114 counts the number of pixels of each of black and white, further recounts the number for white as that for red and the number for black as that for white, and determines whether the image object is the seal imprint image based on the ratio of the counted numbers of pixels or the aspect ratio of the red pixel region.

FIG. 6 illustrates an example of a procedure of the specific image deletion processing.

### Step S71

In step S71, the controller 11 (extraction processing unit 112) extracts the object information from the document data P1. To be specific, the controller 11 extracts a text object, a drawing object (an image object, a path object), and the like from the document data P1.

### Step S72

In step S72, the controller 11 (deletion processing unit 114) determines whether the extracted object as a target object is an image object. If the target object is an image object (Yes in S72), the deletion processing unit 114 proceeds to a process of step S73. On the other hand, if the target object is not an image object (No in S72), the deletion processing unit 114 proceeds to a process of step S8 (underlay background change processing).

### Step S73

In step S73, the controller 11 (deletion processing unit 114) acquires image information used in the rendering processing from the image object. Specifically, the deletion processing unit 114 acquires an image size, the number of bits per pixel (color format), and the like from the image object. Here, when the image size is too small (for example, less than 24 pixels in vertical and horizontal sizes, less than 72 dpi, or the like), or when a width of the image is 90% or more of the horizontal width of a page size and the vertical length is less than 50% of the page size, the deletion processing unit 114 determines that the target object is not a target of the specific image deletion processing and proceeds to the process of step S8 (underlay background change processing).

### Step S74

In step S74, the controller 11 (deletion processing unit 114) determines whether the color format of the image object is 24-bit (RGB) or 32-bit (RGBA). When the color format of the image object is 24-bit or 32-bit (Yes in S74), the deletion processing unit 114 proceeds to a process of step S75. On the other hand, when the color format of the image object is not 24 bits or 32 bits (No in S74), the deletion processing unit 114 proceeds to a process of step S741.

### Step S75

In step S75, the controller 11 (deletion processing unit 114) counts the number of pixels of each of red, black, and white. After counting the number of pixels of each color, the deletion processing unit 114 proceeds to a process of step S76.

### Step S741

In step S741, the controller 11 (deletion processing unit 114) determines whether the color format of the image object is 8-bit (Index Color). When the color format of the image object is 8-bit (Yes in S741), the deletion processing unit 114 proceeds to a process of step S742. On the other hand, when the color format of the image object is not 8-bit (No in S741), the deletion processing unit 114 proceeds to a process of step S744.

### Step S742

In step S742, the controller 11 (deletion processing unit 114) counts the number of pixels of each of black, gray, and white.

### Step S743

In step S743, when a pixel of gray is present, the controller 11 (deletion processing unit 114) recounts the number of pixels of gray as that of red. After counting the number of pixels of each color, the deletion processing unit 114 proceeds to the process of step S76.

### Step S744

In step S744, the controller 11 (deletion processing unit 114) counts the number of pixels of each of black and white.

### Step S745

In step S745, the controller 11 (deletion processing unit 114) recounts the number of pixels of white as that of red, and the number of pixels of black as that of white. After counting the number of pixels of each color, the deletion processing unit 114 proceeds to the process of step S76.

### Step S76

In step S76, the controller 11 (deletion processing unit 114) calculates the ratio of the numbers of pixels and the aspect ratio of the red pixel region. Specifically, the deletion processing unit 114 calculates the composition ratio of the number of red pixels and the aspect ratio of the rectangular sizes of the red pixel region.

### Step S77

In step S77, the controller 11 (deletion processing unit 114) determines whether the image object is an image (seal imprint image) to be deleted based on the composition ratio of the red pixels and the aspect ratio of the red pixel region. The deletion processing unit 114, when determining that the image object is a seal imprint image (Yes in S77), proceeds to a process of step S78. On the other hand, the deletion processing unit 114, when determining that the image object is not a seal imprint image (No in S77), proceeds to the process of step S8 (underlay background change processing).

Note that when the number of red pixels is too large (when a size of the image object is 95% or more of the page size and the counted number of red pixels is 4% or more of the size of the image object) or when black pixels are included (when the size of the image object is 95% or more of the page size and the counted number of black pixels is 0.02% or more of the size of the image object), the deletion processing unit 114 determines that the target object is not a target of the specific image deletion processing.

Further, the deletion processing unit 114 determines that the image object is a seal imprint image, for example, (1) when a range where the red pixels are present is less than ½ of the page size in both the vertical and horizontal sizes, and the counted number of red pixels is more than 7/50 (14%) of the number of all pixels of the size of the image object, and (2) when the range where the red pixels are present is less than ½ of the page size in both the vertical and horizontal sizes, the red pixels are present, the total counted number of red pixels and white pixels is more than 9/10 (90%) of the number of all pixels of the size of the image object, and the counted number of black pixels is less than 5% of the number of all pixels of the size of the image object. However, the deletion processing unit 114 determines that the target object is not a target of the specific image deletion processing when the number of black pixels that are present is only more that 1% of the number of all pixels of the size of the image object, the center position in the vertical direction in a region where the black pixels are present is in a region where the red pixels are present, and an area in the horizontal direction in the region where the black pixels are present includes a portion overlapping even partially the region where the red pixels are present.

The deletion processing unit 114 calculates the aspect ratio of the rectangular sizes of the red pixel region, and makes a final determination under the following three conditions to determine that the target object is to be deleted. To be specific, the deletion processing unit 114 determines that the image object is to be deleted, in a case where the image object is (1) determined to be an image object of 24 or more bits and be a red seal image, and a value obtained by subtracting the aspect ratio of the rectangular sizes from 1 (square) is less than 0.4 (first condition), (2) determined to be an image object of 8 bits or less and be a red seal image, and a value obtained by subtracting the aspect ratio of the rectangular sizes from 1 (square) is less than 0.296 (second condition), or (3) is a red pixel region existing substantially inside the already deleted image object (third condition). As described above, the deletion processing unit 114 may determine that the image object to be deleted when any of the first to third conditions is satisfied. However, in a case where there is an image object that is a full color image and has already been subjected to the deletion processing (image object of 24 bits or more), when an image object to be determined is an image object (8 bits or less) that is not a full color image, the deletion processing unit 114 changes the image object having been determined to be deleted under the above condition to be excluded from the target to be deleted.

### Step S78

In step S78, the controller 11 (deletion processing unit 114) deletes the image object determined as the seal imprint image. After deleting the seal imprint image to be deleted, the deletion processing unit 114 proceeds to the process of step S8 (underlay background change processing).

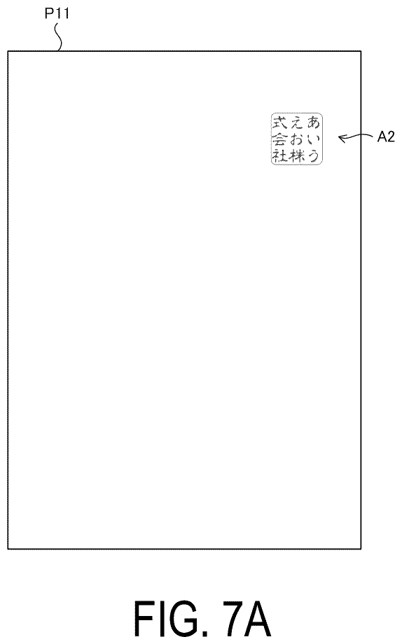

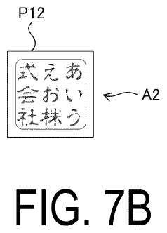

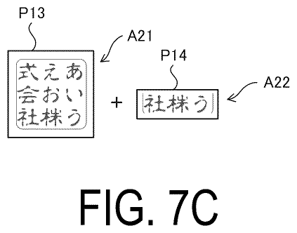

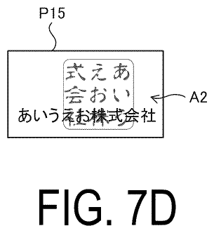

As described above, the deletion processing unit 114 executes the specific image deletion processing. For example, as illustrated in FIG. 7A, when an image object P11 in the page size includes a seal imprint image A2, the deletion processing unit 114 determines the image object P11 to be deleted and deletes the image object P11. As illustrated in FIG. 7B, in a case of an image object P12 including only a seal imprint image A2, the deletion processing unit 114 determines the image object P12 to be deleted and deletes the image object P12. As illustrated in FIG. 7C, when a seal imprint image includes a plurality of images A21 and A22, the deletion processing unit 114 determines an image object P13 including the image A21 and an image object P14 including the image A22 to be deleted and deletes the image objects P13 and P14. Note that, as illustrated in FIG. 7D, in a case of an image object P15 in which a seal imprint image and a company name are integrated, the deletion processing unit 114 excludes the image object P15 from the target to be deleted.

### Underlay Background Change Processing

In the underlay background change processing, when the extraction processing unit 112 extracts a text object from the document data P1, the change processing unit 115 changes a color of at least one of a stroke and a fill based on color information of the stroke being a border portion of a character in the text object and color information of the fill being a portion filled in a region of the character. When the extraction processing unit 112 extracts a path object that is a drawing object from the document data P1, the change processing unit 115 changes a color of at least one of a stroke and a fill based on information on rectangle sizes, color information of the stroke, and color information of the fill of the path object.

FIG. 8 illustrates an example of a procedure of the underlay background change processing.

### Step S81

In step S81, the controller 11 (extraction processing unit 112) extracts the object information from the document data P1. To be specific, the controller 11 extracts a text object, a drawing object (an image object, a path object), and the like from the document data P1.

### Step S82

In step S82, the controller 11 (change processing unit 115) determines whether the extracted object as a target object is a text object. If the target object is a text object (Yes in S82), the change processing unit 115 proceeds to a process of step S83. On the other hand, if the target object is not a text object (No in S82), the change processing unit 115 proceeds to a process of step S86.

### Step S83

In step S83, the controller 11 (change processing unit 115) acquires color information used in the rendering processing from the text object. Specifically, the change processing unit 115 acquires information on a stroke color (color of a border portion of a character) and a fill color (color of a portion filled in a region of the character).

### Step S84

In step S84, the controller 11 (change processing unit 115) determines whether the acquired color is a color to be changed. The change processing unit 115, when determining that the acquired color is a color to be changed (Yes in S84), proceeds to a process of step S85. On the other hand, the change processing unit 115, when determines that the acquired color is not a color to be changed (No in S84), proceeds to the process of step S86. For example, when the stroke color is white and/or the fill color is white, the change processing unit 115 determines that the color is a color to be changed.

### Step S85

In step S85, the controller 11 (change processing unit 115) changes the character color to be changed. Specifically, the change processing unit 115 changes the white stroke color to black and the white fill color to black. After changing the character color to be changed, the change processing unit 115 proceeds to the process of step S9 (rendering processing).

### Step S86

In step S86, the controller 11 (change processing unit 115) determines whether the extracted object as the target object is a path object. If the target object is a path text object (Yes in S86), the change processing unit 115 proceeds to a process of step S87. On the other hand, if the target object is not a path object (No in S86), the change processing unit 115 proceeds to the process of step S9 (rendering processing).

### Step S87

In step S87, the controller 11 (change processing unit 115) acquires color information from the text object. Specifically, the change processing unit 115 acquires information on a stroke color (a color of line) and a fill color (color of a portion filled in a region of surrounded by a line).

### Step S88

In step S88, the controller 11 (change processing unit 115) determines whether the acquired color is a color to be changed. The change processing unit 115, when determining that the acquired color is a color to be changed (Yes in S88), proceeds to a process of step S89. On the other hand, the change processing unit 115, when determines that the acquired color is not a color to be changed (No in S88), proceeds to the process of step S9. For example, when the stroke color is white and the fill color is black, the change processing unit 115 determines that the color is a color to be changed.

### Step S89

In step S89, the controller 11 (change processing unit 115) changes the color to be changed. Specifically, the change processing unit 115 changes the black fill color to white or light gray. After changing the color to be changed, the change processing unit 115 proceeds to the process of step S9 (rendering processing).

As described above, the change processing unit 115 executes the underlay background change processing. Note that the change processing unit 115 excludes a small rectangle in which neither the stroke color nor the fill color is white. The change processing unit 115 excludes a path object representing a thin horizontal line.

When the stroke color is white and the fill color is black, the change processing unit 115 determines whether a target object corresponds to a region to be deleted, and changes only the stroke color to black when determining that the target object does not correspond to the region to be deleted. This is to enable the determination to be made later under the condition that the stroke color and the fill color are black.

In addition, in a case where (1) the fill color is other than white and the stroke color and the fill color are other than black, (2) the stroke color is black and the fill color is other than black, (3) the stroke color is white and the fill color is other than black, and (4) the stroke color is dark and the fill color is bright, the change processing unit 115 determines whether the fill color is a gray color or a chromatic color, then determines whether the target object corresponds to a region to be deleted, and changes the fill color to a bright gray color when determining that the target object corresponds to a region to be deleted.

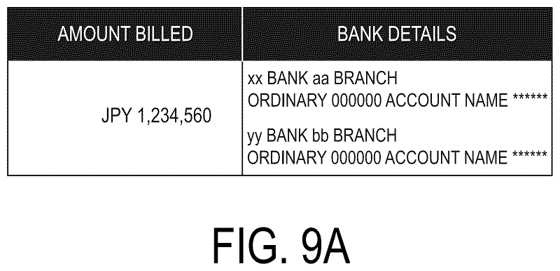

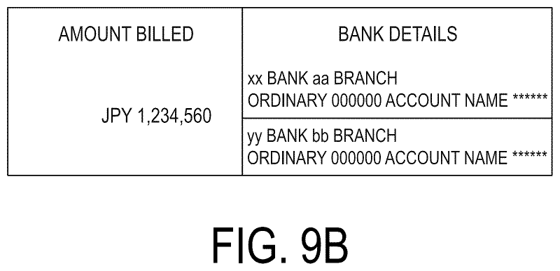

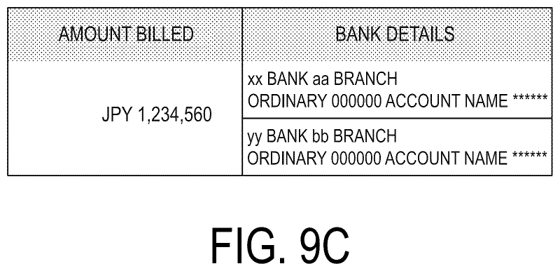

When the change processing unit 115 determines that the target object (a table cell filled with a rectangular color, not a line) is an area to be deleted, it changes the fill color to a light gray color instead of white. For example, in a table illustrated in FIG. 9A, as for the rectangles of “Amount billed” and “Bank details”, cells are expressed only by a fill color. In this case, if the fill color is changed to white, the image cannot be recognized as a table by the OCR preprocessing as illustrated in FIG. 9B. Therefore, in the present embodiment, as illustrated in FIG. 9C, the change processing unit 115 changes the fill color to light gray. This enables recognition as a table in the OCR preprocessing.

The change processing unit 115 may determine whether the target object corresponds to a region to be deleted by the following method.

For example, the change processing unit 115 determines that the target object corresponds to a region to be deleted when any of the following conditions is satisfied: a Bezier curve is not used for drawing a path object, a length of a straight line set for drawing is equal to or greater than a certain length (condition of different lengths in the vertical and horizontal directions), the path object represents a rectangle, and a size of the path object is equal to or greater than a certain size (first condition); a Bezier curve is not used for drawing a path object, the path object has a fill color of gray or chromatic color, the path object represents a rectangle, and a size of the path object is equal to or greater than a certain size (second condition); and a Bezier curve is not used for drawing a path object, the path object does not have a fill color of gray or chromatic color, and the path object is a vertical line having a length equal to or greater than a certain size (third condition).

Further, the change processing unit 115 may count the following two conditions (fourth and fifth conditions), and determine that the path object as the target object is to be deleted when the total counted number is equal to or less than 4 and the size of the path object is equal to or larger than a certain size. The fourth condition is counted, when a Bezier curve is used for drawing a path object in units of path segments in the path object. The fifth condition is counted when a path object does not have a fill color of gray or chromatic color and is a horizontal line having a length equal to or greater than a certain size. However, even if the target object is determined to be deleted because the condition such as the number of counts is satisfied based on any of the three conditions (first to third conditions) or the two conditions (fourth and fifth conditions), the target object is not to be deleted if the rectangle size is equal to or larger than a certain size.

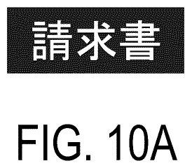

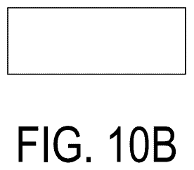

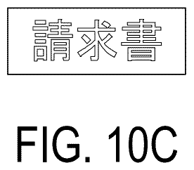

FIG. 10A illustrates an example of a path object in which an outside of a white line is filled with black. The path object illustrated in FIG. 10A is not a text object, and therefore, an inside of the character cannot be filled. Therefore, only changing the fill color to white causes the characters “Invoice” to be unrecognizable as illustrated in FIG. 10B. Therefore, in the present embodiment, the change processing unit 115 changes the fill color to white and changes the stroke color to black as illustrated in FIG. 10C. This enables the inverted character (white character) to be appropriately recognized in the OCR processing.

As described above, the image processing apparatus 1 according to the present embodiment extracts a target object as at least one of a text object and a drawing object (image object, path object) from the document data P1, and executes predetermined correction processing (specific character substitution processing, specific image deletion processing, and underlay background change processing) on the target object when the extracted target object matches an object to be processed that is registered in advance, and generates image data for character recognition by executing rendering processing on the document data P1 of which the target object has been corrected. The image processing apparatus 1 executes character recognition processing on the generated image data and output a recognition result.

According to the above configuration, for example, a character that is included in a text object and is to be garbled is substituted with another character before the rendering processing, and thus the text object can be appropriately rendered. In addition, when the seal imprint image overlaps the text object, the seal imprint image can be deleted and the text object can be rendered. In addition, the color of the background or the color of the character can be changed for rendering. This makes it possible to appropriately render the document data P1, and thus improve the character recognition accuracy of the OCR processing.

The information processing system of the disclosure may be a system that executes any one of the specific character substitution processing, the specific image deletion processing, and the underlay background change processing, or may be a system that executes a combination of some of these types of processing. In the information processing system of the disclosure, the specific character substitution processing, the specific image deletion processing, and the underlay background change processing may be performed in any order.

Note that the controller 11 of the image processing apparatus 1 controls the entire image processing apparatus 1. The controller 11 realizes various functions by reading and executing various programs stored in the storage 12 (for example, storage or ROM). The controller 11 may be implemented by one or multiple control devices/arithmetic devices (such as a Central Processing Unit (CPU), a System on a Chip (SoC)). In addition, the controller 11 may include one or multiple control circuits (electronic circuits).

### Supplementary Notes of Disclosure

Hereinafter, an outline of the disclosure extracted from the above-described embodiments is described as supplementary notes. Configurations and processing functions described in the following supplements can be selected and combined as desired.

### Supplementary Note 1

An information processing system including:
an extraction processing circuit that extracts a target object that is at least one of a text object and a drawing object from document data;
a correction processing circuit that executes predetermined correction processing on the target object extracted by the correction processing circuit when the target object matches an object to be processed that is registered in advance; and
a generation processing circuit that generates image data for character recognition by executing render processing on the document data of which the target object has been corrected by the correction processing circuit.

### Supplementary Note 2

The information processing system according to supplementary note 1, wherein
when the extraction processing circuit extracts an image object that is the drawing object from the document data,
the correction processing circuit determines whether the image object is a seal imprint image to be deleted based on the number of or a region of pixels of a predetermined color among a plurality of pixels included in the image object, and deletes the image object when determining that the image object is the seal imprint image.

### Supplementary Note 3

The information processing system according to supplementary note 2, wherein
the correction processing circuit determines whether the image object is the seal imprint image based on a ratio of the number of pixels of red to the number of pixels of colors other than red among the plurality of pixels included in the image object or an aspect ratio of rectangular sizes of a region of the pixels of red.

### Supplementary Note 4

The information processing system according to supplementary note 3, wherein
the correction processing circuit
   counts, when a color format of the image object is 24-bit or 32-bit, the number of pixels of each of red, black, and white, and determines whether the image object is the seal imprint image based on the ratio of the numbers of pixels or the aspect ratio of the region of the pixels of red,
counts, when the color format of the image object is 8-bit, the number of pixels of each of black, gray, and white, further recounts the number of pixels of gray as that of red in a case where a pixel of gray is present, or recounts the number of pixels of white as that of red and the number of pixels of black as that of white in a case where no pixel of gray is present, and determines whether the image object is the seal imprint image based on the ratio of the numbers of pixels or the aspect ratio of the region of the pixels of red, and
counts, when the color format of the image object is 1-bit, the number of pixels of each of black and white, further recounts the number of pixels of white as that of red and the number of pixels of black as that of white, and determines whether the image object is the seal imprint image based on the ratio of the numbers of pixels or the aspect ratio of the region of the pixels of red.

### Supplementary Note 5

The information processing system according to any one of supplementary notes 1 to 4, wherein
when the extraction processing circuit extracts a text object from the document data, and when a character string in the text object includes a character to be corrected, the correction processing circuit substitutes the character with a predetermined character that is registered in advance in association with the character to be corrected.

### Supplementary Note 6

The information processing system according to supplementary note 5, wherein
the correction processing circuit refers to a storage storing a name of a font to be garbled, a character to be garbled, and an alternative character for substitution in association with each other, identifies the alternative character associated with the character to be corrected that is to be garbled, and substitutes the character with the alternative character.

### Supplementary Note 7

The information processing system according to any one of supplementary notes 1 to 6, wherein
when the extraction processing circuit extracts the text object from the document data, the correction processing circuit changes a color of at least one of a stroke and a fill based on color information of the stroke being a border portion of a character in the text object and color information of the fill being a portion filled in a region of the character.

### Supplementary Note 8

The information processing system according to any one of supplementary notes 1 to 7, wherein
when the extraction processing circuit extracts a path object that is the drawing object from the document data, the correction processing circuit changes a color of at least one of a stroke and a fill based on information on rectangle sizes, color information of the stroke, and color information of the fill of the path object.

### Supplementary Note 9

The information processing system according to any one of supplementary notes 1 to 8, further including:
a recognition processing circuit that executes character recognition processing on the image data generated by the generation processing circuit; and
   an output processing circuit that outputs a recognition result of the recognition processing circuit.

### Supplementary Note 10

An information processing method in which one or more processors performs:
extracting a target object that is at least one of a text object and a drawing object from document data;
   executing predetermined correction processing on the target object when the target object matches an object to be processed that is registered in advance; and
generating image data for character recognition by executing render processing on the document data of which the target object has been corrected.

### Supplementary Note 11

An information processing program or a non-transitory computer-readable recording medium having the information processing program recorded therein, the information processing program causing one or more processors to execute:
extracting a target object that is at least one of a text object and a drawing object from document data;
   executing predetermined correction processing on the target object when the target object matches an object to be processed that is registered in advance; and
generating image data for character recognition by executing render processing on the document data of which the target object has been corrected.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing system comprising one or more processors, wherein
the one or more processors
extract a target object that is at least one of a text object and a drawing object from document data,
execute predetermined correction processing on the extracted target object when the target object matches an object to be processed that is registered in advance, and
generate image data for character recognition by executing render processing on the document data of which the target object has been corrected in the predetermined correction processing.

2. The information processing system according to claim 1, wherein
when the one or more processors extract an image object that is the drawing object from the document data, the one or more processors determine whether the image object is a seal imprint image to be deleted based on the number of or a region of pixels of a predetermined color among a plurality of pixels included in the image object, and delete the image object when determining that the image object is the seal imprint image.

3. The information processing system according to claim 2, wherein
the one or more processors determine whether the image object is the seal imprint image based on a ratio of the number of pixels of red to the number of pixels of colors other than red among the plurality of pixels included in the image object or an aspect ratio of rectangular sizes of a region of the pixels of red.

4. The information processing system according to claim 3, wherein
the one or more processors
count, when a color format of the image object is 24-bit or 32-bit, the number of pixels of each of red, black, and white, and determine whether the image object is the seal imprint image based on the ratio of the numbers of pixels or the aspect ratio of the region of the pixels of red,
count, when the color format of the image object is 8-bit, the number of pixels of each of black, gray, and white, further recount the number of pixels of gray as that of red in a case where a pixel of gray is present, or recount the number of pixels of white as that of red and the number of pixels of black as that of white in a case where no pixel of gray is present, and determine whether the image object is the seal imprint image based on the ratio of the numbers of pixels or the aspect ratio of the region of the pixels of red, and
count, when the color format of the image object is 1-bit, the number of pixels of each of black and white, further recount the number of pixels of white as that of red and the number of pixels of black as that of white, and determine whether the image object is the seal imprint image based on the ratio of the numbers of pixels or the aspect ratio of the region of the pixels of red.

5. The information processing system according to claim 1, wherein
when the one or more processors extract a text object from the document data, and when a character string in the text object includes a character to be corrected, the one or more processors substitute the character with a predetermined character that is registered in advance in association with the character to be corrected.

6. The information processing system according to claim 5, wherein
the one or more processors refer to a storage storing a name of a font to be garbled, a character to be garbled, and an alternative character for substitution in association with each other, identify the alternative character associated with the character to be corrected that is to be garbled, and substitute the character with the alternative character.

7. The information processing system according to claim 1, wherein
when the one or more processors extract the text object from the document data, the one or more processors change a color of at least one of a stroke and a fill based on color information of the stroke being a border portion of a character in the text object and color information of the fill being a portion filled in a region of the character.

8. The information processing system according to claim 1, wherein
when the one or more processors extract a path object that is the drawing object from the document data, the one or more processors change a color of at least one of a stroke and a fill based on information on rectangle sizes, color information of the stroke, and color information of the fill of the path object.

9. The information processing system according to claim 1, wherein
the one or more processors execute character recognition processing on the generated image data and output a recognition result of the character recognition processing.

10. An information processing method performed by one or more processors, the information processing method comprising:
extracting a target object that is at least one of a text object and a drawing object from document data;
executing predetermined correction processing on the target object when the target object matches an object to be processed that is registered in advance; and
generating image data for character recognition by executing render processing on the document data of which the target object has been corrected.

11. A non-transitory computer-readable recording medium having an information processing program recorded therein, the information processing program causing one or more processors to execute:
extracting a target object that is at least one of a text object and a drawing object from document data;
executing predetermined correction processing on the target object when the target object matches an object to be processed that is registered in advance; and
generating image data for character recognition by executing render processing on the document data of which the target object has been corrected.
